(19) United States
(12) Patent Application Publication
(10) Pub. No.: US 2026/0181681 A1
(43) Pub. Date: Jun. 25, 2026

(54) SCHEDULING WITH DEVICE CLASSIFICATION FOR AMBIENT IOT

(71) Applicant: INTERDIGITAL PATENT HOLDINGS, INC, Wilmington, DE (US)

(72) Inventors: Erdem BALA, East Meadow, NY (US); Kevin WANUGA, Souderton (PA); Martino FREDA, Laval (CA); Paul MARINIER, Brossard (CA); Aata EL HAMSS, Laval (CA); Moon IL LEE, Melville, NY (US); Jongwoo HONG, New York, NY (US); Remun KOIRALA, London (GB)

(73) Assignee: INTERDIGITAL PATENT HOLDINGS, INC., Wilmington, DE (US)

(21) Appl. No.: 18/990,820

(22) Filed: Dec. 20, 2024

(51) Int. Cl. H04W 72/51; H04W 72/044

(52) U.S. Cl. CPC H04W 72/51; H04W 72/044

(57) ABSTRACT

One or more systems, methods, devices, and/or approaches to enhance wireless communication techniques are disclosed herein. In one example, a reader may communicate with one or more devices. In some cases, where there is more than one device, the reader may dynamically adjust the resources for each device in order to communicate efficiently and without interference with all of the devices.

### BACKGROUND

Ambient Internet of Things device (AIoT) use radio frequency and/or electromagnetic fields to interact with readers. These devices may contain electronically stored information that may be read from the reader from a distance. IoT and related technology may be used in various applications, including inventory management, access control, and asset tracking, and the like, due to its low energy needs. There is a need for approaches to enhance the communication system surrounding these and similar devices.

### SUMMARY

One or more systems, methods, devices, and/or approaches to enhance wireless communication techniques are disclosed herein. In one example, a reader may communicate with one or more devices. In some cases, where there is more than one device, the reader may dynamically adjust the resources for each device in order to communicate efficiently and without interference with all of the devices.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example process for a Radio Frequency Identification (RFID) tag;

FIG. 3 illustrates an example of a random access procedure for AIoT devices;

FIG. 4 illustrates an example of backscattering modulation;

FIG. 5 illustrates an example of a sample sequence of messages in a slot;

FIG. 6 illustrates an example of timing adjustments for an assigned occasion of a D2R transmission; and

FIG. 7 illustrates an example of a resource adjustment process.

### DETAILED DESCRIPTION

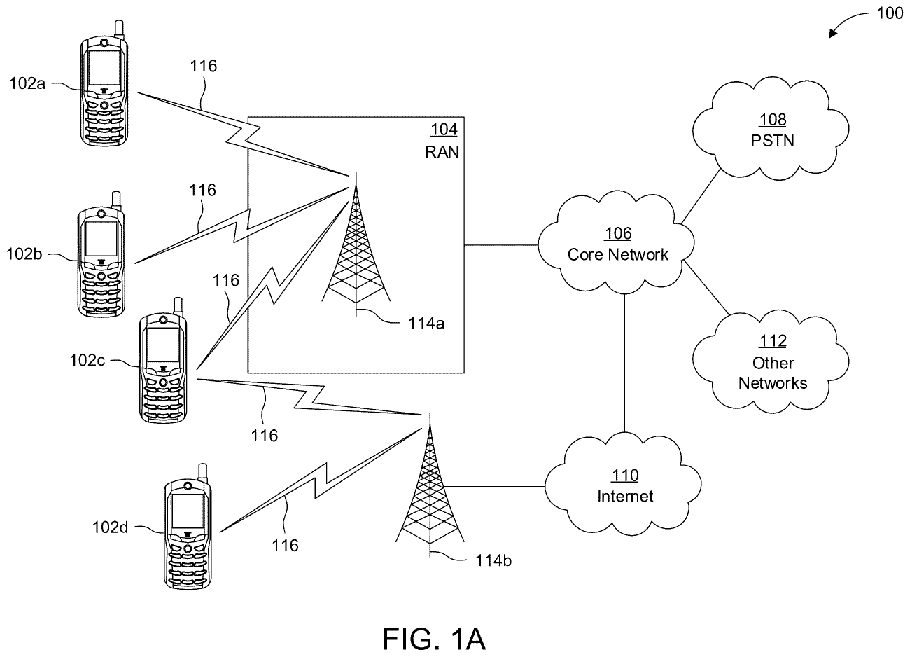

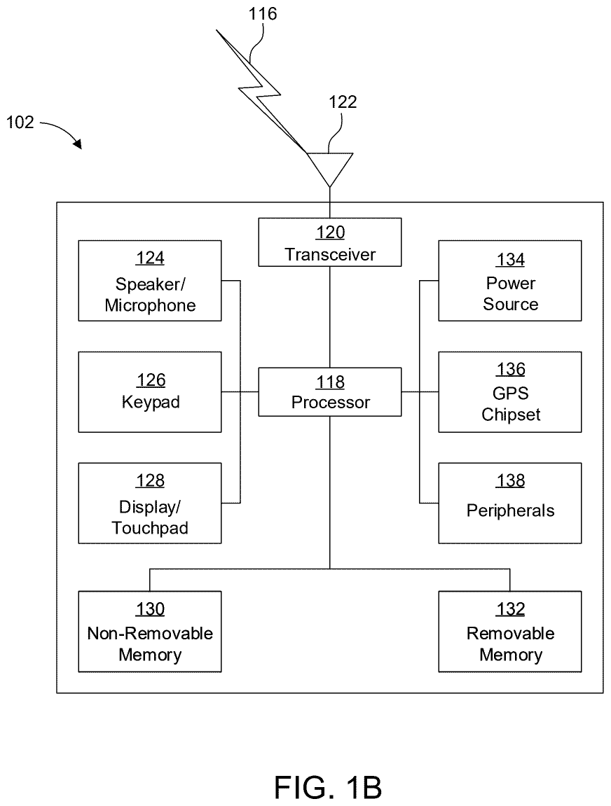

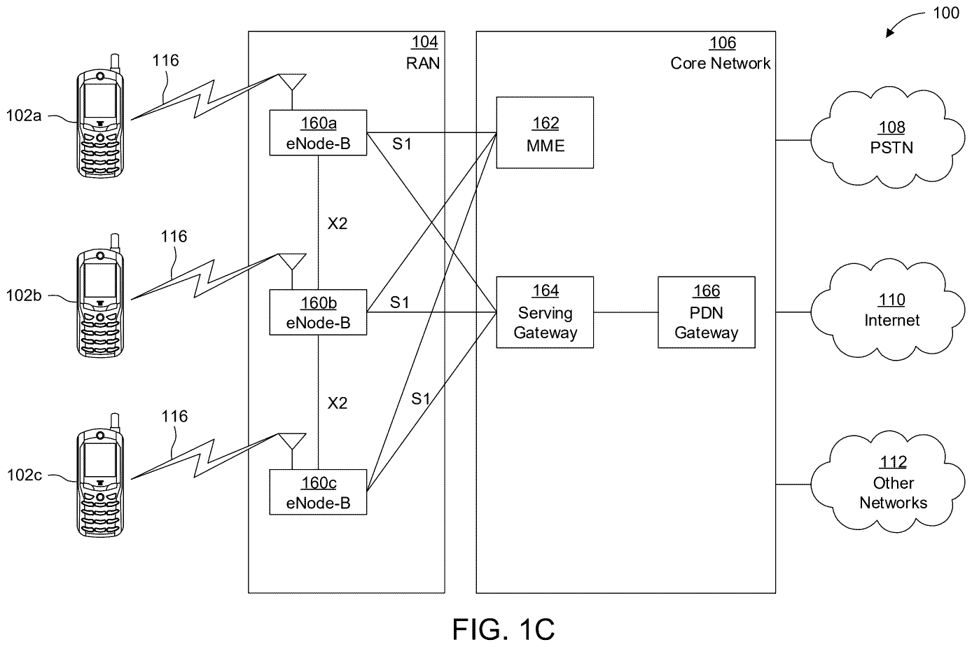

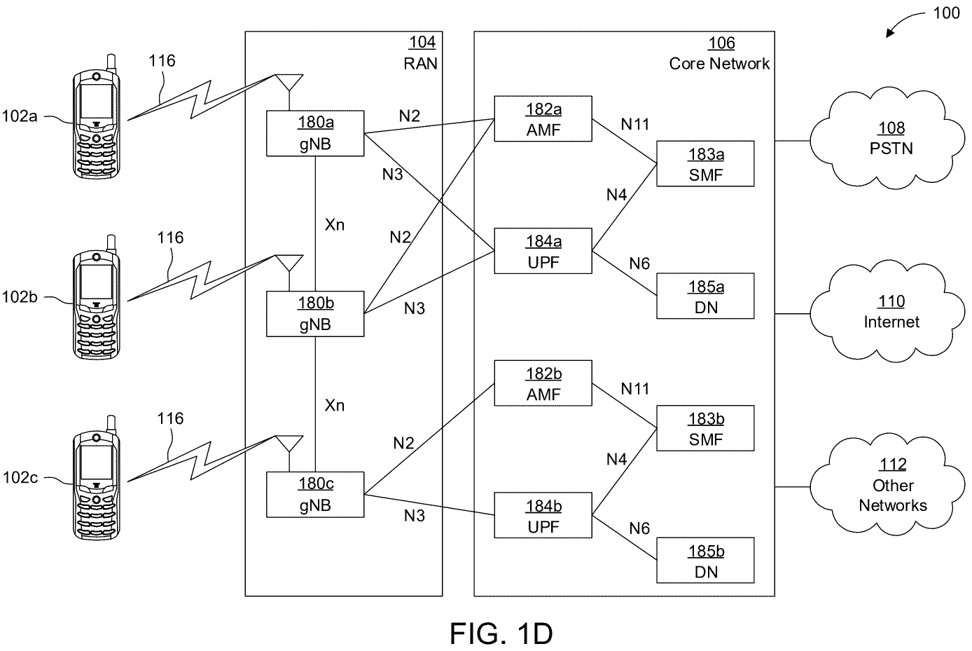

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Generally, an ambient internet of things (IoT) (AIoT) device (e.g., low complexity) may be a small and/or reduced capability IoT device (e.g., relative to another IoT device or other WTRU equivalent) that operates based on ambient energy (e.g., through harvesting energy through some other form of energy, such as radio waves, light, motion, heat, etc.). These devices may either be battery-less or have limited energy storage capabilities. A device may connect to a network via a reader. A reader may be another device, such as a WTRU, or a network node as described herein (e.g., BS, function, etc.); the reader may be interchangeable with either of these terms. Where a device relies on capturing energy from the reader, then whatever device the reader is must be capable of delivering this energy. Alternatively, the device may capture energy for operating from elsewhere besides the reader.

There are various use cases for ambient IoT devices that may serve as the basis for grouping them into different categories (e.g., indoor and outdoor inventory, sensors, positioning, and/or command) and/or by topologies/deployment scenarios. These devices may be further categorized by type based on these groupings and/or other characteristics.

For example, one type (e.g., type 1) of device may operate at ˜1 μW peak power consumption without either DL or UL amplification in the device (e.g., may have neither DL nor UL amplification in the device). This type of device may have energy storage, initial sampling frequency offset (SFO) up to 10^{X} ppm. The device's UL transmission may be backscattered on a carrier wave provided externally.

For example, one type (e.g., type 2a) of device may operate at ˜1 μW peak power consumption with either DL or UL amplification in the device (e.g., may have DL or UL amplification in the device). This type of device may have energy storage, initial sampling frequency offset (SFO) up to 10^{X} ppm. The device's UL transmission may be backscattered on a carrier wave provided externally. This type of device is similar the type 1 device except that it may use DL and/or UL amplification.

For example, one type (e.g., type 2b) of device may operate at ≤a few hundred μW peak power consumption, have energy storage, initial sampling frequency offset (SFO) up to 10^{X} ppm, and/or may have both DL and/or UL amplification in the device. The device's UL transmission may be generated internally by the device, or be backscattered on a carrier wave provided externally.

Generally, all device types may be able to receive and demodulate data and control messages from different RAN entities (e.g., base station, WTRU, network functions, etc.). The manner in which an ambient IoT device connects with a network may be related to the topology of a given system. While specific device types are discussed herein, it is intended that reference to a specific device type is for illustrative purposes, and could be replaced with reference to just a device of any type, unless specified otherwise.

There may be one or more topologies for a network to communicate with an AIoT device. For example, in a first topology (e.g., topology 1), there may be a reader that is a BS that connects (e.g., ambient IoT data/signaling/etc.) to an ambient IoT device. In a second topology (e.g., topology 2), there may be a base station that has an intermediary connection with an intermediary node that acts as the reader, which in turn connects to an ambient IoT device. In all the topologies, the Ambient IoT device may be provided/sent/broadcasted with a signal (e.g., RF carrier, a carrier wave or continuous wave (CW), etc.) from the reader or other node(s) either inside or outside the topology.

Ambient IoT devices (e.g., devices 1 and 2a) may transmit by backscattering a signal transmitted by a reader or a node. The signal may include a single tone or multiple tones transmitted simultaneously (multi-carrier) or sequentially (frequency hopping). A device may transmit information by reflecting or absorbing the signal. As described herein, a node may or may not be a reader. A reader in a given network architecture may have more than one role (e.g., receive/transmit Device to Reader (D2R) and/or Reader to Device (R2D) signals). A node (e.g., either as a reader or as not a reader from the perspective of the network architecture) may have a primary functionality of transmitting a signal to one or more AIoT devices.

A signal may refer to, and be interchangeable with, any signal (e.g., RF signal, RF carrier, carrier wave signal, continuous wave signal, a reference signal, modulated continuous wave signal, sine wave signal, square wave, a message, a transmission, etc.) that may be at least backscattered on by the devices and/or received and/or measured by a reader.

A WTRU may be an ambient Internet of Things (IoT) device, and the two terms may be interchangeable as described herein. Further, an “ambient IoT device” or a “device” may refer to a device (e.g., IoT device) that may be able to transmit and/or backscatter and/or receive data/ID(s) and/or control signals to and/or from RAN entities (e.g., bases station, WTRU, network etc.). A “WTRU” may refer to the reader or an “intermediate WTRU” from the ambient IoT topology 2 and may be used interchangeably with “reader” or “TRP” or “BS” or “Network” or any other entity (e.g., RAN entity) that can transmit and or receive the signals and messages (e.g., data signals, control messages, etc.) with the device or the ambient IoT device.

Any device/WTRU referenced herein may be configured by a reader, whereby the reader may be a network node or other device/WTRU (e.g., intermediate WTRU in topology 2). In the case of a WTRU, the WTRU may derive the device configuration itself, or receive the device configuration from the network, in which case, the device configuration may be relayed from the network to the device by the WTRU.

The term “other reader” or “another reader” may refer to one or more reader nodes (e.g., TRP, intermediate WTRU, etc.) that may transmit R2D signals and/or receive the D2R signals. In one example, the readers may be within the vicinity of the WTRU or a node or one or more device(s).

The WTRU may receive configuration (e.g., in the case of a reader WTRU in topology 2), indications, messages, requests, etc., from a network node (e.g., a BS, gNB, etc.) or another reader (e.g., intermediate WTRU) via downlink physical channel (e.g., PDSCH, PDCCH, etc.) or via lower or higher layer signaling (e.g., DCI, MAC-CE, SIB, RRC or LPP message) from the network.

In one example a WTRU may perform reporting, send messages, indications, requests, etc. to a network node (e.g., a BS, gNB, etc.) or another reader node (e.g., intermediate WTRU) via uplink physical channel (e.g., PUSCH, PUCCH, etc.) or via lower or higher layer signaling (e.g., UCI, RRC, UL-MAC CE) to the network.

The term “transmission characteristic” may refer to one or more of the configurations and/or transmission parameters (e.g., time, frequency, transmission power, transmission beam, etc.) of a signal.

The proximity between two entities may refer to a distance between them being below/above/at a certain threshold.

The conditions for the determination of one parameter (e.g., configuration parameter, e.g. related to at least one procedure) may depend on one or more factors. A WTRU may determine one value for the parameter if at least one of the factors are at/above a (pre)configured threshold, and another value if the factor is at/below a (pre)configured threshold.

In backscattering, a device reflects a received signal after modulating the signal using a baseband signal. Baseband physical layer processing may use line codes for digital baseband modulation. In a line code, digital bits are encoded into one or a sequence of pulses. For example, bit 1 may be encoded as a pulse with level +A and bit 0 may be encoded as a pulse of level 0. As disclosed herein, A=1 is assumed without loss of generality. In another example, bit 1 may be encoded as a pulse with level +A and bit 0 may be encoded as a pulse of level −A. In another example, bit 1 may be encoded as a half-pulse with level 0 (or −A) followed by a half-pulse with level A and bit 0 may be encoded as a half-pulse with level +A followed by a half-pulse with level 0 (or −A). This last encoding scheme is known as Manchester encoding.

An IoT device may use backscatter modulation to transmit data to a reader. In backscattering, an IoT device may not generate an signal (e.g., RF carrier) but receives it from an external source and reflects the received signal (e.g., RF signal). The baseband signal may be modulated on the reflected RF carrier. This may be achieved by using the impedance mismatch concept. An antenna impedance may be connected to a load impedance at the device. By changing the reflection coefficient (e.g., by adjusting the load impedance) over time, the amplitude, frequency, etc. of the reflected signal may be changed. For example, ON-OFF keying modulation may be achieved by using (e.g., non-reflecting state/OFF signal) or (reflecting state/ON signal). An RFID device may utilized backscatter communications wherein RFID tags switch the reflection coefficient between two states based on the data being sent. ASK and PSK may be supported by the RFID tags.

In some methods, digital bits may be encoded as a sequence of pulses without using a line code. For example, bit 1 may be encoded as a square wave over a finite duration with a first periodicity and bit 0 may be encoded as a square wave over a finite duration with a second periodicity, etc. One baseband processing method that may be used in RFID is subcarrier modulation. A subcarrier signal (e.g., a square wave) may be used to multiply the line coded signal. The multiplication may be achieved by a XOR operation (e.g., if voltage levels are unipolar) or scalar multiplication (e.g., if voltage levels are polar). The resulting signal may then be transmitted using backscatter modulation. As described herein, unless otherwise specified such as for RF carrier signal, all signals may be baseband signals.

With subcarrier modulation, the spectrum of the line coded signal may be shifted wherein the shift may be determined by the chip duration of the subcarrier signal. Using this technique, transmission from multiple devices may be multiplexed in frequency, such as by having devices perform subcarrier modulation using subcarrier signals corresponding to different frequencies. For example, a device may use a subcarrier signal with chip duration Tc while another device may use a subcarrier signal with chip duration 2×Tc. Another method to shift the spectrum of a Manchester encoded signal is to reduce the codeword duration such that the codeword is repeated N times within a bit duration where N determines the amount of the frequency shift.

Generally, there may be many type of procedures related to AIoT depending on the use case and the radio technology being utilized. Radio Frequency Identification (RFID) tags may be used for asset identification. An RFID tag may be similar to an AIoT device, and any techniques described herein with respect to one of these devices may be applicable to the other. In an inventory procedure, an interrogator (e.g., reader) may send a query message to energize all or a subset of tags. Following a query message, at least one tag may select a random number from 0-2\hat{ }-1 and load its memory with that number. The number Q may be signaled in the query message and may determine the number of slots defined for the procedure. The interrogator may repeat sending the query (QueryRep) to the tag. For each transmission of a QueryRep (e.g., which may indicate a new time period, e.g., time slot), the tag may decrement its counter until the counter reaches 0. Following each transmission of a QueryRep, there may be dedicated read/writing for a specific or set of tags. When the counter reaches 0 (i.e., the current slot is the slot the tag has randomly selected), the tag may initiate a contention resolution procedure, which may include transmitting its device ID to the reader and/or waiting for confirmation of the device ID from the reader (e.g., to address possible collision between multiple devices selecting the same random number). For a tag that has passed contention resolution, the reader may send multiple commands (e.g., read/write, etc.), to which the tag should respond (e.g., follow the command). The interrogator may continue to transmit QueryReps until it has completed interrogating all or a set of tags. The process may be repeated depending on configuration parameters (e.g., periodically, a-periodically, etc.). For example, the time interval between each QueryRep may be referred to as a slot. In each slot, the reader may communicate with a different tag. This tag may start communicating when its random number hits zero.

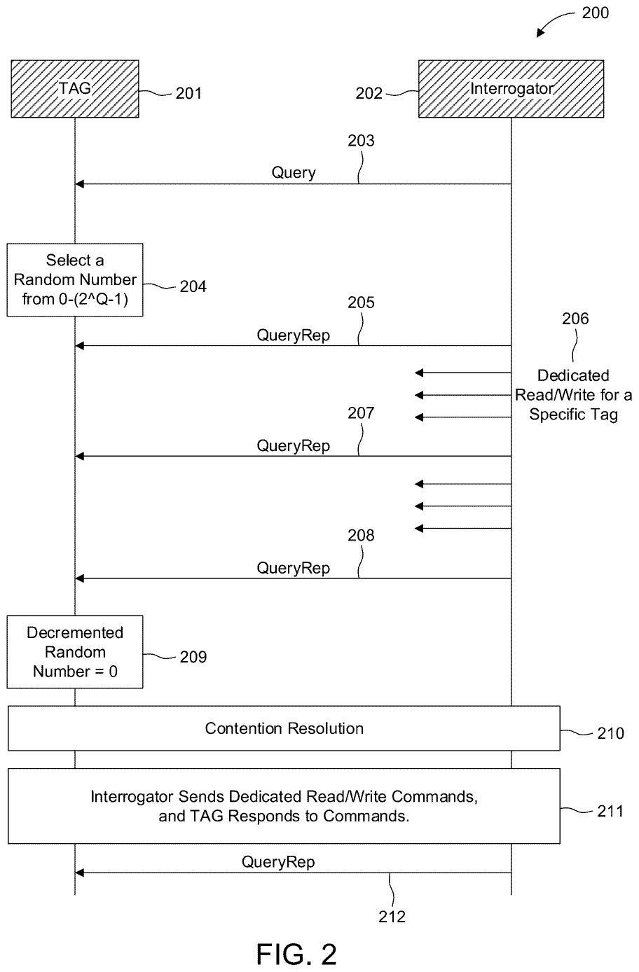

FIG. 2 illustrates an example process for a Radio Frequency Identification (RFID) tag. One or more techniques described herein may be applicable to this example even though it may not be shown in the figure. As shown, there is a tag 201 and an interrogator 202. In a process 200, a query message is sent at 203. At 204 the tag may select a random number. At 205, 207, 208, and 212, the query may be repeated (QueryRep). The tag decrements the random number with each QueryRep command. After 205, for example, at 206 there is a dedicated read/write for a specific tag. At 209, the tag decrements the random number to 0, at which point contention resolution at 210 is performed. At 211, the integrator sends a dedicated read/write command to the tag, and the tag responds to the commands.

Generally, in order to communicate with an AIoT device, there may need to be some approach for initiating and carrying out communication. A random access procedure may be used for AIoT devices. This random access approach may include the transmission of one or more messages after a device determines its transmission occasion. A reader (e.g., integrator, WTRU, base station, etc.) may transmit an initial message (e.g., trigger, paging, sync, RACH, etc.) to all, a set, or one or more devices. The initial message may be used to select a device and/or indicate a new occasion (e.g., a given time period, such as a slot). This may also be transmitted before, or at some point during, an inventory procedure, such as described herein (e.g., before, as part of, or after a query message). As part of the random access procedure, a series of messages (msg1, msg2, msg3, etc.) may be exchanged. A device may send msg 1. Msg1 may include an ID (e.g., random, assigned, etc.), and/or other information as disclosed herein. Msg2 may be sent from the reader to the device. Msg 2 may include a response to msg1, which may include the ID from msg1 and/or other information as disclosed herein. Msg3 may be sent from the device to the reader. Msg3 may include another ID other than the initial transmitted one, application layer data, and/or other information as disclosed herein. Msg 3 may represent the successful completion of the random access procedure, however, in some instances additional or other steps may be taken if the procedure is not completed successfully. Certain aspects may be repeated or modified a configured number of times, which may ultimately result in success or failure. Note, that as described herein, the reader may be a node of the network or may be an intermediary that facilitates the relay of a payload between the device and the network.

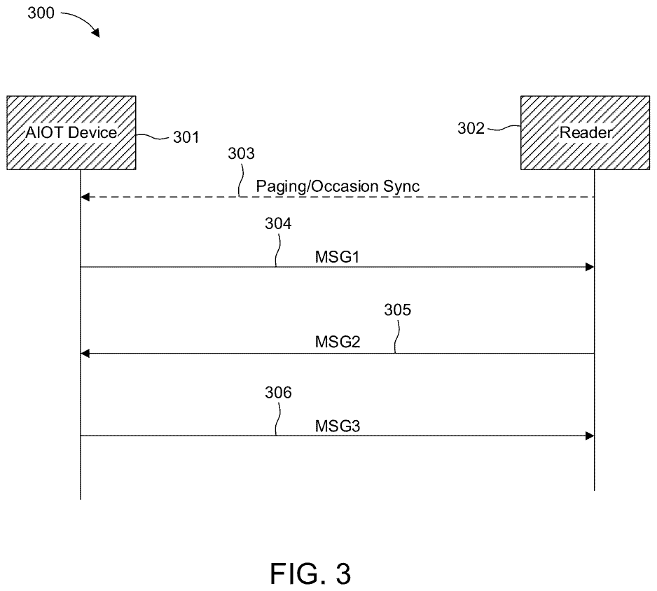

FIG. 3 illustrates an example of a random access procedure for AIoT devices. One or more techniques described herein may be applicable to this example even though it may not be shown in the figure As shown, there is an AIoT device 301 and a reader 302. A random access procedure 300 may include a paging/occasion sync message at 303. The random access procedure 300 may include one or more aspects disclosed herein that is or is not illustrated in this example figure. At 304, msg1 may be sent from the device to the reader. At 305, msg2 may be sent as a response to msg1 from the reader. At 306, the device may send msg3 to the reader (e.g., as a success completion of the random access procedure, where the device can deliver a payload).

In some cases, the approaches described herein may be applicable to devices other than the examples provided herein (e.g., examples herein that refer to AIoT devices performing backscattering). They may also be applicable to any devices that generate an RF carrier (e.g., that does not need an external carrier), and other wireless devices. A reader may use On-Off Keying (OOK) modulated signal to transmit a baseband signal to a device. The baseband signal may be a line encoded signal. In one example, an OFDM-based OOK waveform with subcarrier spacing of 15 kHz may be used for (R2D) transmission(s). The physical channels from the reader and from the device may be a preconfigured channel. For example, such a channel may be include PRDCH (Physical Reader-to-Device Channel) and/or PDRCH (Physical Device-to-Reader Channel).

In some cases, system efficiency may need to be increased, and it may be desirable to multiplex multiple D2R messages (e.g., msg3 from multiple devices). If a reader sends scheduling information for each D2R occasion, this may result in higher overhead, which may or may not be acceptable depending on operating goals. Additionally, devices may not be able to transmit in a scheduled resource (e.g., time and/or frequency) as a result of high sampling frequency due to device clocks having comparatively lower accuracy. To address these concerns, and to present transmissions from multiple devices to overlap (e.g., and create interference), gaps in the resources may be helpful (e.g., time and/or frequency buffer).

As described herein, the terms device, AIoT, IoT, device, and tag may be used interchangeably to mean the device that is communicating (e.g., transmitting, receiving, interrogating, querying, etc.) with a reader. The term reader may refer to a network node or a WTRU, depending on the context and/or the topology (e.g., as described herein). The approaches disclosed herein are intended to be applicable to scenarios beyond the examples provided herein, such as where the AIoT device is instead replaced with a WTRU and the reader is another WTRU or a network node.

Generally in backscattering, a device reflects a received signal after modulating the signal using a baseband signal. Baseband physical layer processing may use line codes for digital baseband modulation. In a line code, digital bits are encoded into one or a sequence of pulses. For example, in a line encoding scheme, bit 0 is encoded as a pulse of amplitude 1 followed by a pulse of amplitude 0; and bit 1 is encoded as a pulse of amplitude 0 followed by a pulse of amplitude 1 (e.g., where this is known as Manchester encoding). The bit (or symbol) duration is denoted as Ts. A chip may be defined as the smallest unit of pulse and the amplitude of a chip is assumed to be constant over the chip duration Tc. A symbol may comprise of one or more chips, for example, each Manchester symbol is composed of two chips (e.g., spanning Ts). The device is able to transmit its desired message by modulating the RF carrier wave according to the baseband line code.

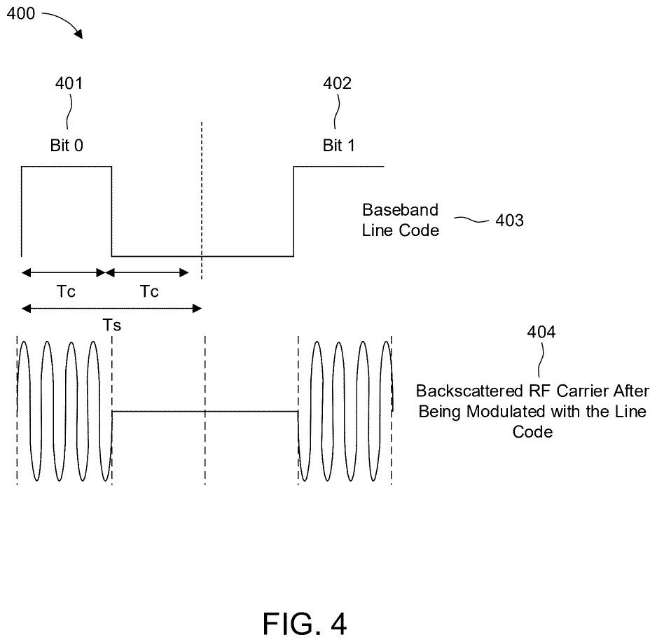

FIG. 4 illustrates an example of backscattering modulation. One or more techniques described herein may be applicable to this example even though it may not be shown in the figure. This example may be assumed that a carrier has been sent and that a device is performing backscattering modulation. As shown, a carrier at 404 has been modulated with the line code: At 401, the baseband line code is bit 0 and at 402 the baseband line code is bit 1. Note, that each chip of the line code aligns with the modulation of the carrier, as shown at 404. In this example, the amplitude of the backscattered signal is changed depending on the value of the line code chip. For example, when a baseband chip has value 1, the received RF carrier is reflected as it is during the duration of Tc; when a baseband chip has value 0, the received RF carrier is absorbed by the device, and nothing is backscattered.

AIoT devices, along with any other device or WTRU mentioned herein, may have many use cases. One such use case is inventory tracking/managing, etc., and this is used herein to illustrate different techniques that may involve the communication system for the devices/reader/network, etc. Inventory may generally refer to the overall procedure of a reader triggering access by multiple devices using a sequence of messages (e.g., similar to query, followed by query rep in the example of RFID). An inventory procedure may refer to a single round of attempts to have each device respond or attempt to respond with the desired response (e.g., its access ID, perform a RACH procedure with a payload, etc.). An inventory procedure may refer to a set of access occasions that may have 0 or at least 1 device respond within the access occasion.

An occasion or time period as described herein may refer to the opportunity for device transmission that may be delimited by the transmission of another message (e.g., query rep message, or similar). Specifically, a device may perform transmission in an occasion by performing an AIoT transmission in a defined time following a triggering transmission associated with that AIoT transmission. Alternatively/additionally, an occasion may comprise a time aspect and/or a frequency aspect. Specifically, a device may determine an occasion as a transmission following a specific triggering transmission, and by transmitting on one of a number of frequencies (e.g., FDM). Wherever approaches indicate selection of an occasion herein, they may apply equally to selection of a time component, a frequency component, and/or a time and frequency component.

A reader may communicate with more than a single device within a time occasion (e.g., a slot, etc.), where transmission from devices and/or transmission to devices may be multiplexed in time and/or frequency. For example, multiple devices may transmit msg1 to a reader using separate time/frequency resources; similarly multiple devices may transmit msg3 to a reader using separate time/frequency resources. The reader may also transmit multiple messages (e.g., msg2) to multiple devices by multiplexing the messages in time and/or frequency.

As described herein, any reference to time may be associated with an absolute time measurement (e.g., seconds, slots, frames, etc.). Alternatively, reference to time may refer to a number of executions of a procedure, possibly triggered by a reader (e.g., number of inventory procedures, number of accesses or RACH procedures, etc.). Alternatively, reference to time may refer to a number of messages, possibly of a specific type, or containing specific information, as described herein, received or transmitted.

Configuration or pre-configuration may refer to any configuration received by a message (e.g., an RRC message, a MAC CE, a PHY layer signal, a data PDU, a control PDU associated with any or a new protocol layer, etc.) received from either a network node, or from another device, or WTRU. A device as described herein may be configured by a reader, whereby the reader may be a network node or a WTRU. In the case of a WTRU, the WTRU may derive the device configuration itself, or receive the device configuration from the network, in which case the device configuration is being relayed from the network to the device by the WTRU. A WTRU configuration may be received from a network node (e.g., base station or other network function).

For a given message exchange between a device and a reader, there may be a sequence of messages in a slot (e.g., a slot as in a slotted ALOHA scheme, which is a medium access control (MAC) protocol for transmission of data via a shared channel). A reader may transmit a random access trigger to trigger D2R transmission from one or a plurality of devices. The trigger may be a signal (e.g., a predefined sequence), a message (e.g., a QueryRep, etc.), or other carrier disclosed herein. Alternatively, a device may determine to trigger D2R transmission without a transmission from the reader (e.g., a device may determine to transmit at a predefined time). Devices transmitting msg1 may be multiplexed in time and/or frequency. A device may select a time and/or frequency resource randomly, based on reconfiguration, or based on a received explicit or implicit indication.

The reader may transmit a message (e.g., msg2) to the devices (e.g., to those devices from which a msg1 is successfully received). The reader may transmit a single msg2 to a plurality of devices or a separate msg2 for each device.

In one approach, a device may transmit in a designated D2R channel, for example, as a response to a R2D message. For example, R2D transmission may comprise a msg2 and the D2R transmission may comprise a msg3. The reader may indicate to the device(s) scheduling information of the transmission occasions for the D2R transmission. The scheduling information may be wholly or partially included in the R2D message triggering the D2R transmission. The scheduling information (e.g., implicit and/or explicit) may include one or more elements.

For example, the scheduling information may include a time occasion for a D2R transmission occasion. The information associated with a time occasion may include one or more of the start time of the occasion (e.g., when the occasion starts), the duration of the occasion, and/or other related information. The start time of an occasion may be with respect to a reference, for example, with respect to an end of the R2D transmission triggering the D2R transmission, or some other transmission. For example, the D2R occasions may be indicated by the reader to start at some time t1, t2, t3, which may be measured from the end of the R2D message. The unit of time may be seconds, chip duration (e.g., duration of the R2D chip triggering the D2R transmission), some measurement disclosed herein, and/or a function of the duration of at least one R2D signal.

For example, the scheduling information may include an ID of the scheduled device for transmission in an occasion

For example, the scheduling information may include at least one parameter associated with D2R data rate (e.g., D2R chip duration, D2R coding rate, backscatter link frequency, etc.)

For example, the scheduling information may include an adjustment of the occasion (e.g., an adjustment of the time domain resource or frequency resource). For example, an adjustment to the start time of an occasion, wherein the start time of some occasion may be adjusted to start earlier or later by a delta/offset value.

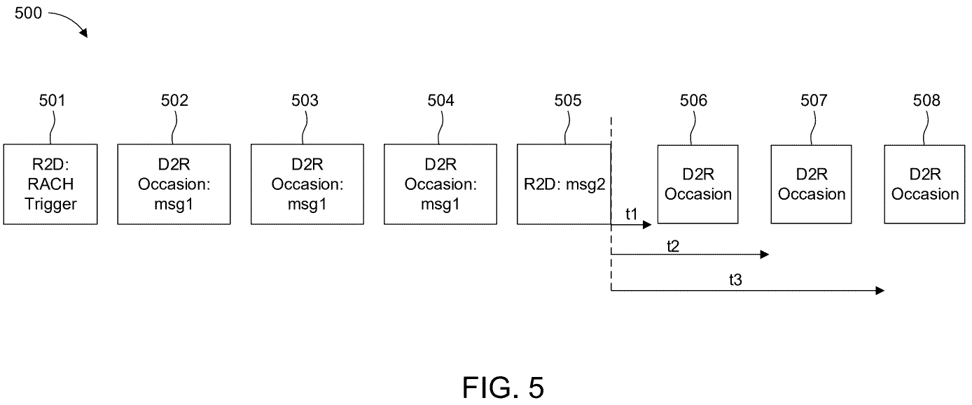

FIG. 5 illustrates an example of a sample sequence of messages in a slot. One or more techniques described herein may be applicable to this example even though it may not be shown in the figure. As shown, at 501 a reader sends a RACH trigger. At 502, 503, and 504, there are multiple occasions where a msg1 might be sent (e.g., as understood by the reader). At 505, the reader sends a msg2. Following the msg2 (e.g., where the timing is relative to msg2), the device has multiple occasions to send a message (e.g., msg3) to the reader, such as 506 t1, 506 t2, and 508 t3.

In one example similar to FIG. 5, in each occasion of the multiple msg1 occasions (e.g., in one slot), a separate device of a plurality of devices may send msg1 (e.g., where each device utilized one occasion) (e.g., this is different from RFID where only a single tag may send msg1 in a slot). Then for msg3, the same devices (e.g., that sent msg1) may be scheduled to transmit msg3 to the reader. So, in one slot, the reader may communicate with three devices in this example instead of only one (e.g., compared to an RFID approach). From this example, it may be understood that different aspects of different approaches may be combined to achieve a process, where the specific aspects of a given approach may be selected depending on the design requirements.

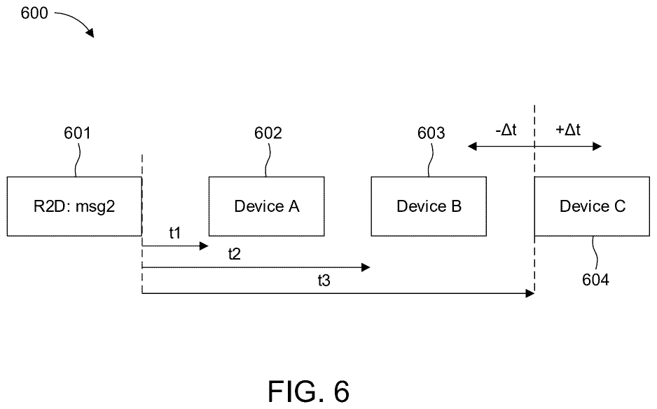

FIG. 6 illustrates an example of timing adjustments for an assigned occasion of a D2R transmission. One or more techniques described herein may be applicable to this example even though it may not be shown in the figure. As shown, a R2D msg2 may be sent at 601. Subsequently, there may be several time occasions for a given device to respond with a msg3, at 602, 603, 604. An adjustment to the start time of an occasion of device C is shown, where the start time of the third occasion (at t3) is adjusted to start earlier or later by a delta value.

A reader may transmit part of the scheduling information for an occasion in a message targeting a plurality of devices, for example in a scheduling message, such as a paging message, a query message, or some separate message. Such a message may be referred to as a common message. The scheduling information may be valid for a given time (e.g., for all slots defined for a procedure), or for one or a plurality of slots. The common message may include the starting times (e.g., t1, t2, t3) of occasions.

Resources for msg3 transmission may be ordered in time and/or frequency and the device may determine its resource based on the order of its random ID in msg2. The ordering in time and/or frequency may be configured in a common message (e.g., the paging message).

The resource for a msg3 transmission for a device may be changed by an offset from the order indicated initially, by receiving in a message (e.g., in or with msg2) a resource offset. For example, if msg2 includes a resource offset, the device may skip a number of resources (e.g., in the order given by msg2) given by the offset to determine the resource on which it transmits msg3.

A reader may transmit an adjustment of a start time of an occasion to the device for which the occasion is allocated for D2R transmission. The reader may transmit the adjustment in the R2D transmission (e.g., msg2) triggering the D2R transmission. The reader may transmit the adjustment in a R2D transmission within the slot associated with the scheduled D2R transmission, for example, in a R2D transmission indicating the starting of the slot (e.g., similar to a QueryRep message), and/or a RACH trigger message.

A reader may determine an adjustment value for a device (e.g., in part or exclusively) by performing a measurement from at least one of the multiplexed devices. For example, the reader may use the msg1 transmission from a device to perform a measurement. In one instance, the reader may determine an estimate of the sampling frequency offset of the device based on the measurement performed on the msg1 transmission. The reader may also indicate that the adjustment should be added or subtracted from the start time, for example using a 1-bit indication.

A reader may configure (e.g., using a control message) a finite set of scheduling parameters (e.g., a set of start times, a set of adjustment values, etc.) and indicate scheduling parameters from the set of configured parameters. For example, the reader may configure k start time values and/or n adjustment values and may indicate for a device one of k start times and/or one of n adjustment values. In one instance, it may use log 2k and/or log 2n bits, respectively, for k start times and/or n adjustment values. A device may determine the transmission occasion from the indicated scheduling parameter and the adjustment value.

A reader may indicate an adjustment to the frequency resource allocation of a device. The reader may indicate D2R transmission occasions (e.g., time/frequency occasion) using one or more parameters.

For example, a parameter may indicate an index to a configured occasion, for example the occasion may be defined using a link frequency or a backscatter link frequency. Note that a link frequency may be associated with a chip duration, for example link frequency may be defined as LF=1/(2Tc) where Tc may be the duration of a D2R chip.

For example, a parameter may indicate an index to a chip duration

For example, a parameter may indicate a chip duration

For example, a parameter may indicate an index to a link frequency

For example, a parameter may indicate a link frequency

For example, a parameter may indicate an index to a repetition factor (as applied by a device to Manchester codeword repetition within a bit duration)

For example, a parameter may indicate a repetition factor (as applied by a device to Manchester codeword repetition within a bit duration)

The frequency occasions may be indicated/configured in a common message, as disclosed herein for time domain occasions. In some instances, the reader may configure a set of possible link frequencies, based on one or more (e.g., configured) factors.

For example, a factor may include defining a set of chip durations for a subcarrier signal.

For example, a factor may include defining a set of number of chips of a subcarrier signal within a bit duration.

For example, a factor may include defining a set of number periods of a subcarrier signal within a bit duration.

For example, a factor may include defining a set of repetition factors as applied to a line codeword (e.g., Manchester line code within a bit duration).

A device, upon selecting a time resource (e.g., a slot) may select a frequency resource randomly. The device may transmit in the time/frequency occasion a D2R transmission, such as a msg1.

A reader may indicate an adjustment in a R2D message (e.g., in msg2). The adjustment may be applied by a device in a subsequent D2R transmission, such as a msg3 transmission. The adjustment may include information.

For example, the adjustment information may include an indication of scaling of the D2R chip duration (e.g., by an integer k×Tc). The indication may be an integral value (or a fractional value) to apply to the chip duration or an index to a value.

For example, the adjustment information may include an indication to increase or decrease a chip duration. For instance, the increase/decrease amount may be indicated/configured, and the adjustment may include a one-bit to indicate increasing or decreasing by the configured amount. The adjustment may also include an integer to scale the configured amount.

For example, the adjustment information may include a number of repetitions within one bit duration (e.g., of a Manchester codeword).

For example, the adjustment information may include scaling of the link frequency. The indication may be an integral or a fractional value to apply to the chip duration or an index to a value.

For example, the adjustment information may include an indication to increase or decrease the link frequency. For instance, the increase/decrease amount may be indicated/configured, and the adjustment may include a one-bit to indicate increasing or decreasing by the configured amount. The adjustment may also include an integer to scale the configured amount.

In some cases, multiple devices may participate in a random-access procedure to access channel resources and complete a transmission or reception. In a given random access occasion as described herein, such as an slotted-ALOHA slot, that may be indicated by the reader to all or a group of devices via an initiating trigger as described herein, such as an QueryRep, multiple resources or resource sets may be configured for msg1 transmission by multiple devices. The time and frequency resources for these msg1 transmissions may be indicated by the reader as part of the triggering signal indicating the beginning of a process.

After a device has transmitted a msg1 in an indicated msg1 resource, a device may be expected to monitor for a msg2 response from the reader indicating successful reception of msg1. The reference, start time, and/or duration for a monitoring window for possible msg2 response may be indicated by the reader to the device. This indication may be transmitted by the reader in the R2D transmission indicating the beginning of a process or random-access procedure, or it may be transmitted at the beginning of each time resource (e.g. slotted-ALOHA slot) as part of another transmission as disclosed herein (e.g., QueryRep, etc.).

The relevant parameters for msg2 monitoring window configuration may be associated with device classification, such as device type or device capability. As an example, a reader may provide a msg2 a first monitoring window configuration indication including timing reference, window start time, and/or window duration for a first device type. It may transmit another indication for a second monitoring window configuration for a second device type. The monitoring window configurations may have different configurations for each device classification. As an example, a reader may provide an indication for monitoring window configuration for a short period of time immediately after msg1 transmission by a device with poor clock accuracy (e.g., device type 1), and a second longer window at a later start time for a device with high clock accuracy (e.g., device type 2b).

A reader may indicate a separate reference timing for the monitoring window based on device classification as well. As an example, a device with poor clock accuracy may reference its monitoring window immediately after the resource in which its msg1 transmission was sent, while a device with high clock accuracy may reference its monitoring window after the configured resource in which a msg1 transmission could be sent by any device.

Alternatively, a reader may indicate a set of possible monitoring window configurations as part of its system information. This system information could be transmitted as part of the transmission indicating the beginning of a process, or it could be transmitted periodically as part of an R2D transmission relaying relevant configuration information. A reader may indicate in a given time resource (e.g., slotted-ALOHA slot, delimited by an e.g. QueryRep) a subset of monitoring window configurations from the full set of monitoring window configurations may be applicable in the current occasion (e.g., slot).

Each configuration from the subset of applicable configurations may be associated with a subset of resources configured for msg1 transmission by a device. As an example, a reader may indicate a first set of resources for msg1 transmission by a first device classification (e.g., device type 1), and a first monitoring window configuration associated with the msg1 resource set. The reader may also indicate a second set of resources for msg1 transmission by another device classification (e.g. device type 2b) and a second monitoring window configuration associate with the second msg. 1 resource set.

In one example, a reader may send a set of resource assignments (e.g., time and/or frequency) in a message; this message may be a paging message, a sync message, and/or any other type of message. The reader may receive a first message (e.g., msg1, as explained herein), from one or more devices. Based on this first message and/or other information, the reader may determine device specific (e.g., to a set of one or more devices) resource adjustment information (e.g., adjusting time and/or frequency assignments). The reader may send a second message that includes the specific resource adjustment information. This information may include a start instance measured from another transmission (e.g. time and/or frequency). This information may include a resource offset value (e.g., adding or subtracting) from an existing resource (e.g., time and/or frequency) assignment. This information may modify, cancel, and/or replace existing resource assignment information. The second transmission may be a msg 2 transmission, as described herein. In some instances, the resource assignment may be included in the second message, and the resource adjustment information may be transmitted after (e.g., in the same or later message). The reader may monitor for a third message. The third message may be msg3 as described herein. The third message may be monitored for on the original resource assignments, or it may be monitored for on whatever time period the resource adjustment information indicated or is associated with. The device may be indicated explicitly or implicitly the time period in which to transmit the third message. There may be multiple time periods to transmit (e.g., in the case of a situation where it is known multiple repetitions may be needed, e.g., like levels for coverage enhancement, e.g., more repetitions for different levels); this may be indicated by the reader in a message, or preconfigured. There may be multiple power levels to transmit on (e.g., in the case of a situation where it is known multiple repetitions may be needed, e.g., like levels for coverage enhancement, e.g., higher power levels for a different levels); this may be indicated by the reader in a message, or preconfigured.

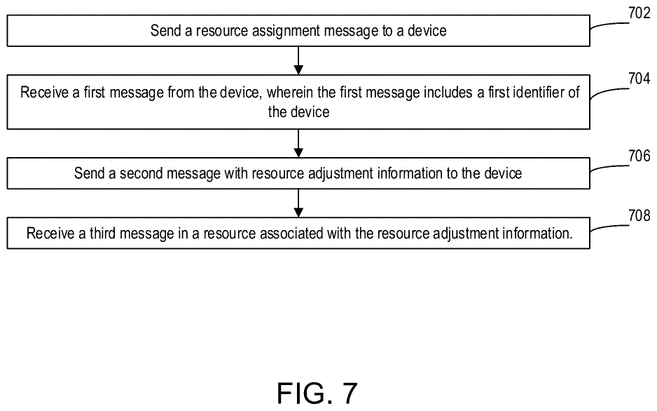

FIG. 7 illustrates an example of a resource adjustment process. One or more techniques described herein may be applicable to this example even though it may not be shown in the figure. In this example, there may be a reader communicating with an AIoT device. At 702, the reader may send a resource assignment message to the device. At 704, the reader may receive a first message from the device. In one instance, the first message includes a first identifier. At 706, the reader may send a second message with resource adjustment information specific to that device. In one instance, the second message may include the first identifier. At 708, the reader may receive a third message in a resource associated with the resource adjustment information from the device. This example may be applicable to multiple devices, such as where multiple devices may be multiplexed to transmit within the same slot. This example may be applicable to multiple devices, such as where multiple devices may use different frequencies.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non-Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein. In one example, a base station may be distributed (e.g., different units that address or include different functions/layers/protocols/hardware/etc.; a first unit, second unit, etc.).

Although features and elements are described above in particular combinations (e.g., embodiments, methods, examples, etc.), one of ordinary skill in the art will appreciate that each feature or element can be used alone or in any combination with the other features and elements. For example, as disclosed herein there may be a method described in association with a figure for illustrative purposes, and one of ordinary skill in the art will appreciate that one or more features or elements from this method may be used alone or in combination with one or more features from another method described elsewhere. A symbol ‘/’ (e.g., forward slash) may be used herein to represent ‘and/or’, where for example, ‘A/B’ may imply ‘A and/or B’. As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’ or indicate that something “does happen” or “can happen”. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

As described herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) as used herein, unless otherwise indicated, represents ‘and/or’, where for example, ‘A/B’ may imply ‘A and/or B’.

As described herein, “etc.” may refer to etcetera, which is intended to reference any other like element in a list, or reference some other element disclosed herein. For example, if a list has “a, b, c, etc.” and another list disclosed herein discloses “a, b, c, d, e” then it is intended that the “etc.” may refer to at least “d, e” or “etc.” may generally refer to other letters in the alphabet.

As described herein, “at least one of” may be interchangeable with “one or more of”.

As described herein, reference of a configuration may mean that at some point a WTRU may receive a message that includes configuration information. In one instance, the WTRU may provide feedback after having received it. In one instance, the WTRU may request the message. In one instance, the message may be unrequested.

As described herein, a “TRP” may be used interchangeably with a base station (BS) (e.g., a gNB).

As described herein, a “Network” may refer to a BS and/or other nodes/functions/entities (e.g., gNB/AMF/UPF/LMF etc.).

As described herein, “pre-configuration” and “configuration” may be used interchangeably.

As described herein, an “ID(s)” may be used interchangeably with index/indices and/or identifier.

As described herein, an “occasion” may refer to an opportunity for device transmission that may be delimited by the transmission of a query rep message (or similar). Alternatively, an occasion may include both a time aspect and a frequency aspect. Wherever description indicates a selection of an occasion, such a reference may apply equivalently to the selection of a time component and/or selection of a frequency component.

Configuration or pre-configuration may refer to any configuration received by a message (e.g., an RRC message, DCI, a MAC CE, a PHY layer signal, a data PDU, a control PDU associated with any or a new protocol layer, etc.) received from either a network node or from another device or WTRU.

In the context of the figures and their corresponding descriptions, some terms used herein may have specific meanings, may be interchangeable with other terms as explained, and/or may have generally accepted meanings as they are known at the time of filing.

What is claimed:

1. A method comprising:
sending a resource assignment message to a device, wherein the resource assignment message includes an initial resource assignment for the device;
receiving a first message from the device, wherein the first message includes a first identifier of the device;
sending a second message with resource adjustment information to the device with instructions to adjust the initial resource assignment of the device; and
receiving a third message in a resource associated with the resource adjustment information.

2. The method of claim 1, wherein the second message includes the first identifier of the device.

3. The method of claim 1, wherein the resource adjustment information includes a transmission start instance measured from an end of a triggering transmission.

4. The method of claim 3, wherein the transmission start instance is applicable to when the third message is received, and the second message is the triggering transmission.

5. The method of claim 1, wherein the resource adjustment information includes a time offset value including and an indication to add or subtract the time offset value to a time domain resource from the resource assignment message.

6. The method of claim 1, wherein the resource adjustment information includes a new frequency value and an indication to alter a frequency domain resource from the resource assignment message based on the new frequency value.

7. The method of claim 1, wherein an additional second message with additional resource adjustment information is sent to an additional device when the second message is sent or after the second message is sent, wherein an additional third message is received in an additional resource associated with the additional resource adjustment information, wherein the resource associated with the resource adjustment information is different than the additional resource associated with the additional resource adjustment information, wherein both the resource associated with the resource adjustment information and the additional resource associated with the additional resource adjustment information are in the same slot.

8. A reader, the reader comprising:
a processor and a transceiver, the processor and transceiver configured to send a resource assignment message to a device, wherein the resource assignment message includes an initial resource assignment for the device;
the processor and transceiver configured to receive a first message from the device, wherein the first message includes a first identifier of the device;
the processor and transceiver configured to send a second message with resource adjustment information to the device with instructions to adjust the initial resource assignment of the device; and
the processor and transceiver configured to receive a third message in a resource associated with the resource adjustment information.

9. The reader of claim 8, wherein the second message includes the first identifier of the device.

10. The reader of claim 8, wherein the resource adjustment information includes a transmission start instance measured from an end of a triggering transmission.

11. The reader of claim 10, wherein the transmission start instance is applicable to when the third message is received, and the second message is the triggering transmission.

12. The reader of claim 8, wherein the resource adjustment information includes a time offset value including and an indication to add or subtract the time offset value to a time domain resource from the resource assignment message.

13. The reader of claim 8, wherein the resource adjustment information includes a new frequency value and an indication to alter a frequency domain resource from the resource assignment message based on the new frequency value.

14. The reader of claim 8, wherein an additional second message with additional resource adjustment information is sent to an additional device when the second message is sent or after the second message is sent, wherein an additional third message is received in an additional resource associated with the additional resource adjustment information, wherein the resource associated with the resource adjustment information is different than the additional resource associated with the additional resource adjustment information, wherein both the resource associated with the resource adjustment information and the additional resource associated with the additional resource adjustment information are in the same slot.
